(19) United States
(12) Patent Application Publication
(10) Pub. No.: US 2024/0259321 A1
(43) Pub. Date: Aug. 1, 2024

(54) DATA TRAFFIC QUALITY ANALYSIS

(71) Applicant: Telefonaktiebolaget LM Ericsson (publ), Stockholm (SE)

(72) Inventors: Ádám ZLATNICZKI, Csongrád (HU); Botond VARGA, Budapest (HU); Gábor MAGYAR, Dunaharaszti (HU)

(21) Appl. No.: 18/565,674

(22) PCT Filed: Jun. 23, 2021
(86) PCT No.: PCT/EP2021/067135

§ 371 Date: Nov. 30, 2023

(51) Int. Cl. H04L 47/2416; H04L 47/2475

(52) U.S. Cl. CPC H04L 47/2416; H04L 47/2475

(57) ABSTRACT

We generally describe a method for analyzing data traffic quality of data traffic flowing between a user equipment and a server of a video service provider. The data traffic includes video traffic and audio traffic. The method includes separating, in the data traffic, the video traffic from the audio traffic, and analyzing, based on the separated video traffic, the data traffic quality of the data traffic flowing between the user equipment and the server of the video service provider.

### TECHNICAL FIELD

The present disclosure generally relates to a method, an apparatus and a network function for analyzing data traffic quality of data traffic flowing between a user equipment and a server of a video service provider.

### BACKGROUND

Generally, video traffic has the largest share among mobile data traffic. It is predicted that the amount of video traffic in mobile networks may grow significantly over the coming years in particular due to an increasing number of video-capable smart devices. Video traffic is thus estimated to account for approximately three-quarters of all total mobile data traffic by 2024. Furthermore, the spread of 5^{th} generation (5G) may bring significant improvements in network performance and may pave the way for immersive media technologies, such as, but not limited to 360-degree video streaming and augmented/virtual reality applications, which may further contribute to the rapid growth of video traffic.

Nowadays, video traffic is generally mostly encrypted. As a result, analysis and management of mobile video traffic are becoming more and more difficult. Over the last decade, transport-level encryption has spread rapidly, and it is expected that transport-level encryption intensifies even more over the coming years. The ratio of encrypted traffic has already reached 80% globally, and close to 100% if one considers Over-The-Top (OTT) Internet service providers (ISPs).

It is important to analyze video quality of experience. In particular, analysis of video traffic is important for Mobile Network Operators (MNOs) as it has a large impact on customer experience. For customers to have good experience, MNOs may need to have good estimates of key performance indicators (KPIs), such as, but not limited to video bitrate, resolution, stall time and video mean opinion score (MOS) so as to optimize the MNOs networks for adequate/improved customer experience.

FIG. 1 is a flow diagram of a method 100 according to the state-of-the-art. As can be seen, raw IP traffic is provided for traffic classification (S102). IP packets are hereby processed and traffic classification is applied thereto, followed by (conditional) video QoE calculation (S104).

Traffic classification may be a process of assigning a service (for example Facebook newsfeed, YouTube video, Google Maps, etc.) to each TCP/UDP packet (or rather, connection). Since a user may consume different services at the same time, this may be important so that the overall traffic may need to be split into services and analyzed separately from a QoE perspective. Traffic qualification may either simply label the traffic, or it may act as a router (so depending on the service, it may send the filter traffic to different QoE measurement modules that are best suited for that kind of traffic).

It is a challenge to analyze video quality of experience in view of the high share of video traffic among total mobile data traffic and in light of most of the video traffic being encrypted.

### SUMMARY

Accordingly, there is a need for optimizing data traffic quality analysis of data traffic flowing between a user equipment and a server of a video service provider.

According to an aspect of the present disclosure, there is provided a method for analyzing data traffic quality of data traffic flowing between a user equipment and a server of a video service provider. The data traffic comprises video traffic and audio traffic. The method comprises separating, in the data traffic, the video traffic from the audio traffic. The method further comprises analyzing, based on the separated video traffic, the data traffic quality of the data traffic flowing between the user equipment and the server of the video service provider.

By separating audio and video traffic, for example, quality of experience (QoE) computation methods may provide for more accurate video QoE metrics.

In some examples, the data traffic quality comprises a quality of experience relative to the data traffic. The quality of experience relative to the data traffic relates, in some examples, to a quality of experience of the video traffic.

In some examples, the method further comprises, prior to said separating the video traffic from the audio traffic, reconstructing, from one or more data packets in the data traffic, one or more request-response pairs from corresponding, respective requests sent from the user equipment to the server and respective responses sent from the server to the user equipment. Separating the video traffic from the audio traffic comprises, in some examples, separating the video traffic from the audio traffic within the one or more reconstructed request-response pairs. Analyzing of the data traffic quality of the data traffic may be based on the video traffic which is separated from the audio traffic within the reconstructed one or more request-response pairs.

In some examples, a plurality of the request-response pairs are reconstructed from a plurality of the data packets.

In some examples, the reconstructing is based on packet header information in the one or more data packets.

In some examples, the method further comprises assigning the one or more data packets to one or more connections between the user equipment and the server. The one or more request-response pairs are reconstructed on a per-connection basis.

In some examples, processing the one or more data packets is performed by a network entity or network function which is different from a network entity or network function by which processing of the one or more request-response pairs is performed.

In some examples, the method further comprises filtering out, prior to said separating of the video traffic from the audio traffic, one or more request-response pairs. The filtering out of the one or more request-response pairs may be dependent on a said video service provider.

In some examples, whether to filter out a said request-response pair is based on a request size of a request, to which the request response-pair corresponds, sent from the user equipment to the server.

In some examples, a said request-response pair is filtered out if the request size is below an average request size of requests sent from the user equipment to the server over a predefined time period.

In some examples, a said request-response pair is filtered out (i) if the request size is above the average request size of requests sent from the user equipment to the server over the predefined time period and (ii) if a ratio of requests with request sizes above the average request size to all requests is below a predefined value.

In some examples, a said request-response pair is filtered out if the ratio of requests with request sizes below the average request size to all requests is below a further predefined value.

In some examples, the data traffic flows in an uplink direction from the user equipment to the server. In particular, in some examples, analyzing of the data traffic quality is based on a plurality of uplink data packets.

In some examples, said separating the video traffic from the audio traffic is performed while the user equipment receives video-content via the data traffic.

In some examples, the method further comprises filtering out the audio traffic from the data traffic flowing between the user equipment and the server prior to said analyzing of the data traffic quality.

In some examples, the separated video traffic and the separated audio traffic each comprise a corresponding, respective indicator for indicating the separated video traffic and the separated audio traffic, respectively. Analyzing of the data traffic quality may be based on the separated video traffic indicated by the corresponding indicator.

In some examples, the method further comprises analyzing, based on the separated audio traffic, the data traffic quality of the data traffic flowing between the user equipment and the server of the video service provider. In some examples, the method further comprises analyzing a video traffic quality based on the separated video traffic, and analyzing, independent from the analysis of the video traffic quality, an audio traffic quality based on the separated audio traffic.

In some examples, analyzing of the data traffic quality is based on one or more key performance indicators computed for the separated video traffic.

In some examples, the method further comprises, prior to said analyzing of the data traffic quality, removing one or more or all requests, in particular one or more or all POST requests, sent from the user equipment to the server.

In some examples, separating of the video traffic from the audio traffic is based on a size of a request sent by the user equipment to the server. In particular, in some examples, separating of the video traffic from the audio traffic is based on a linear discriminant function being applied to the size of the request sent by the user equipment to the server. More particularly, the linear discriminant function may comprise, in some examples, a combination of linear discriminant functions given by different time windows.

In some examples, separating of the video traffic from the audio traffic comprises applying a separating hyperplane to data in the data traffic.

In some examples, the linear discriminant function and/or the separating hyperplane is defined by an average request size of requests sent from the user equipment to the server. In particular, in some examples, a request is identified as a video request if the request size is above the average request size, and a request is identified as an audio request if the request size is below the average request size.

In some examples, the method further comprises, prior to said separating of the video traffic from the audio traffic, applying majority voting to determine whether a said request-response pair is considered as audio traffic or video traffic.

In some examples, the method further comprises splitting the data traffic on a per-service basis relative to one or more services provided by the service provider. The analyzing may comprise analyzing the data traffic quality separately for one or more of the one or more services. In particular, in some examples, dependent on a said service, the audio traffic is either filtered out from the data traffic or is analyzed, separately from the video traffic, for data traffic quality analysis.

In some examples, the method further comprises removing one or more control messages in data in the data traffic prior to said separating the video traffic from the audio traffic. In particular, in some examples, the one or more control messages are removed based on a determination that a size of a message is below a predefined threshold.

In some examples, the data traffic comprises encrypted data traffic, in particular encrypted video traffic.

In some examples, the data traffic comprises non-encrypted data traffic, in particular non-encrypted video traffic.

In some examples, the data traffic comprises a Transmission Control Protocol traffic stream. Additionally or alternatively, in some examples, the data traffic comprises a User Datagram Protocol traffic stream.

According to a further aspect, there is provided a computer program product comprising program code portions that, when executed on at least one processor, configure the processor to perform the example implementations of the methods outlined throughout the present disclosure, and in particular the method of any one of the example implementations outlined above. The computer program product may, in some examples, be stored on a computer-readable recording medium or encoded in a data signal.

According to a further aspect, an apparatus or network function for analyzing data traffic quality of data traffic flowing between a user equipment and a server of a video service provider is provided, whereby the data traffic comprises video traffic and audio traffic. The apparatus or the network function is configured to separate, in the data traffic, the video traffic from the audio traffic. Furthermore, the apparatus or the network function is configured to analyze, based on the separated video traffic, the data traffic quality of the data traffic flowing between the user equipment and the server of the video service provider.

The apparatus is, in some examples, adapted to perform the method of any one of the example implementations outlined throughout the present disclosure, and in particular the method of any one of the example implementations outlined above.

### BRIEF DESCRIPTION OF THE DRAWINGS

Further aspects, details and advantages of the present disclosure will become apparent from the detailed description of exemplary embodiments below and from the drawings, wherein:

FIG. 1 is a flow diagram of a method according to the state-of-the-art;

FIG. 2 is a flow diagram of a method according to some example implementations as described herein;

FIG. 3 is a flow diagram of a method according to some example implementations as described herein;

FIG. 4 is a flow diagram of a method according to some example implementations as described herein;

FIG. 5 is a flow diagram of a method according to some example implementations as described herein;

FIG. 6 is an implementation of a method according to some example implementations as described herein;

FIG. 7 is a flow diagram of a method according to some example implementations as described herein; and

FIG. 8 is a block diagram of a network according to some example implementations as described herein.

### DETAILED DESCRIPTION

In the following description, for purposes of explanation and not limitation, specific details are set forth in order to provide a thorough understanding of the present disclosure. It will be apparent to one of skill in the art that the present disclosure may be practiced in other embodiments that depart from these specific details.

While, for example, the following description focuses on an exemplary network configuration in accordance with 5G specifications, the present disclosure is not limited in this regard. The present disclosure could, for example, also be implemented in other cellular or non-cellular wireless communication networks, such as those complying with 4^{th} generation (4G) specifications (e.g., in accordance with the Long Term Evolution (LTE) specifications as standardized by the 3^{rd} Generation Partnership Project (3GPP)).

Those skilled in the art will further appreciate that the steps, services and functions explained herein may be implemented using individual hardware circuits, using software functioning in conjunction with a programmed microprocessor or general purpose computer, using one or more application specific integrated circuits (ASICs) and/or using one or more digital signal processors (DSP). It will also be appreciated that when the present disclosure is described in terms of a method, it may also be embodied in one or more processors and one or more memories coupled to the one or more processors, wherein the one or more memories store one or more computer programs that perform the steps, services and functions disclosed herein when executed by the one or more processors.

In the following description of exemplary implementations, the same reference numerals denote the same or similar components.

The present disclosure relates in particular to segmenting audio and video requests in video traffic streams. The data/video traffic may hereby, in some examples, be encrypted. The video stream may be an OTT video stream for which quality of experience may be analyzed.

When a mobile subscriber uses a video streaming service (for example YouTube, Netflix, Facebook, etc.), the content may have an audio stream as well as a video stream. If the traffic is not segmented into audio and video traffic, depending on the use-case, this may introduce a bias into an estimation method for determining quality (of experience) of the data traffic.

In some cases, an MNO may not be interested in the audio quality of a video session. However, when network conditions worsen, this may change. For example, in the case of bitrate, if the audio and video streams are not treated separately, the estimated bitrate may be the sum of the audio and video bitrate. In case of high-quality videos, the video bitrate may be at least one order of magnitude larger than the audio bitrate, so that the bias may be comparatively small (for example roughly under 10%). However, when network conditions are insufficient (that is network quality is below a threshold), so that the video resolution is very low (under a threshold), the audio and video bitrate may be of the same order of magnitude. The estimated bitrate may then be up to roughly double the original video bitrate. This example shows that not separating the two kinds of traffic (i.e. audio traffic and video traffic) may have a severe (or the most severe) impact when it may be the least desired, that is in cases where customer experience is affected in a negative way.

Instead of seeing the actual effect, one may only see an estimate which reflects (much) better video quality than the original. Since video resolution is related to bitrate, it may suffer in a similar way. In addition, the type of content may also have a misleading effect: if someone is watching a music video with a constant background, then the video traffic may again be of the same order of magnitude as the audio traffic. Regardless of video resolution, a still image may be compressed significantly. Therefore, video resolution estimates would be biased downwards, indicating bad customer experience even though quality of experience is sufficiently high (so a false positive alarm may be generated). In some instances, music videos may be given their own “resolution label”, for which audio and video traffic may need to be separated.

Furthermore, since audio traffic is generally smaller than video traffic, it is common (although not necessary) for video player clients to download audio data in a single Hypertext Transfer Protocol (HTTP) request, unlike video traffic which may take several requests. It may thus be preferable to identify periodic patterns by analyzing audio requests only.

Example implementations according to the present disclosure allow for analyzing quality of experience based on traffic which is robust in relation to network conditions. Furthermore, example implementations according to the present disclosure consider characteristics of requests sent from the user equipment to the server.

Based on example implementations as described herein, adaptive solutions are provided which take into account the possibility of request sizes potentially changing significantly, whereby, for example, a new video may have a very different URL than the previous video.

Outlier requests may be handled according to example implementations as described herein, whereby these outlier requests may have sizes above or below certain thresholds. Outliers may be removed in a very specific way that is designed to suit characteristics of video streaming, enabling the use of a highly adaptive linear discriminant function. The linear discriminant function may be used in order to separate the audio and video content based on a request size of a request sent from the user equipment to the server. The predictions of several discriminant functions given by different time windows may hereby be combined.

Further still, example implementations according to the present disclosure may, in some examples, take into account multiple uplink packets, so that it may be prevented that requests that exceed a Maximum Transmission Unit (MTU) size spoil upcoming predictions.

According to the present disclosure, one or more nodes or one or more (e.g. virtualized) network functions, or a system which comprises such node(s) and/or (virtualized) network function(s) may be provided, which can analyze captured raw network traffic between a user equipment and a video service provider's server, which may be generated while the user is watching a video online.

Examples as described herein may be implemented, e.g., independently both from the core network and the radio network. A Network Management (NM) function may consume traffic and various type of data both from the core network and the radio network. Examples outlined herein may, e.g., not receive an input from the radio network. The tapping part of the solution (where the Internet Protocol (IP) packets enter the analysis) may be close to the core network elements (interfaces) so that the tapping (which may be expensive) can be efficient. The Packet Filtering, Connection/Flow Separation, and Partial Request-Response Reconstruction parts of the solution may be implemented “near” the tapping point (first level analysis). When the tapping is performed and the first level of analysis has been completed, smaller data structures may be generated and sent to detailed analysis. This second level analysis may be performed by a set of algorithms. It may also be possible to perform this second level of analysis in the cloud.

Example implementations as described herein may introduce a module that separates online the audio and video streams of the typically encrypted mobile data traffic.

The system may partially reconstruct HTTP requests and their corresponding responses. As a result, only properties that are meaningful may be restored in some cases for further analysis, such as size, direction, arrival time and length.

Performance may be improved by filtering the requests, if necessary, for example by removing (e.g.) POST requests sent from the user equipment to the server.

The system may identify if a response to a given request carries video and/or audio content by using, in some examples, (quickly) adapting separating hyperplanes on the request sizes (not the response sizes). Before updating the hyperplane, outliers may be removed.

Based on example implementations as described herein, audio and video traffic in encrypted or non-encrypted video streams, which rely, for example, on Dynamic Adaptive Streaming over HTTP (DASH)-like protocols (either over Transmission Control Protocol (TCP) or User Datagram Protocol (UDP)), may be separated.

Example implementations according to the present disclosure may be used to separate audio and video key performance indicators (KIPs) for the video stream traffic, whereby the video KPIs are more accurate.

Partial request-response reconstructions may be applied so as to analyze quality of experience of the data traffic.

Example implementations involve advanced filtering, utilizing partial reconstruction and characteristics of request types.

In some examples, partial request-response reconstruction may rely solely on packet header information, such as, e.g., source/destination address and port, and/or packet size, and/or packet arrival time, which makes it computationally more efficient. It may also work regardless of the traffic being unencrypted or encrypted, because it does not rely on deep packet inspection. The proposed way to do partial reconstruction may handle cases with large request sizes (exceeding MTU).

Unnecessary traffic in the form of request-response pairs is filtered out easier, since those are the atomic units of data transmission from the point of view of the application layer, so that it may therefore be easier to formulate meaningful rules for them.

Using the request size (and not the response size) for separation may be much more robust. For good quality videos, either of them may work fine. However, for low quality videos, the audio and video traffic may be almost equal, rendering response size based segmentation potentially impossible. On the other hand, request sizes (practically, URL lengths) may be unaffected by this.

Furthermore, using simple separating hyperplanes may make segmentation also computationally more efficient, allowing real-time application. Different videos or different resolutions are available at different URLs that may vary in length widely, therefore sudden level shifts are expected and must be handled—quickly changing separating hyperplanes make this possible.

However, highly adaptive methods are generally vulnerable to the emergence of outlier requests. Such outliers may be quite common (they may be meta-data requests by the client, or reports to the server), and may (potentially seriously) affect detecting performance—by filtering them first, the method becomes robust, yet remains highly adaptive.

The proposed solution may be implemented in a streaming fashion, fitting into modern cloud native data pipelines/architectures.

The solution works on both TCP and UDP traffic (such as the QUIC protocol).

By separating audio and video streams, the existing QoE computation methods may provide more accurate video QoE metrics. In addition, separate QoE metrics may be available for the audio stream as well.

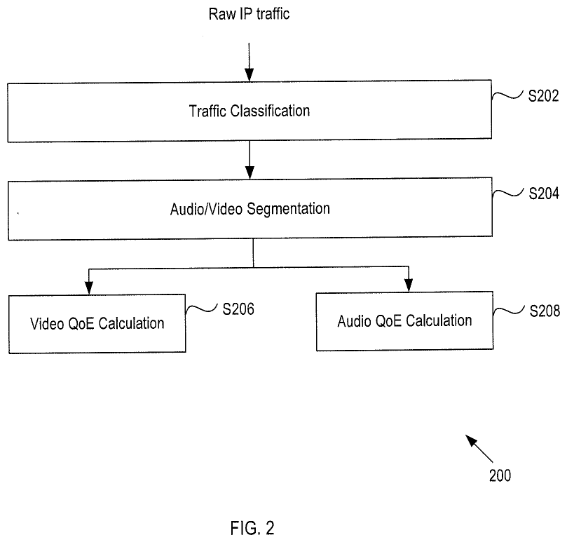

FIG. 2 is a flow diagram of a method 200 according to some example implementations as described herein.

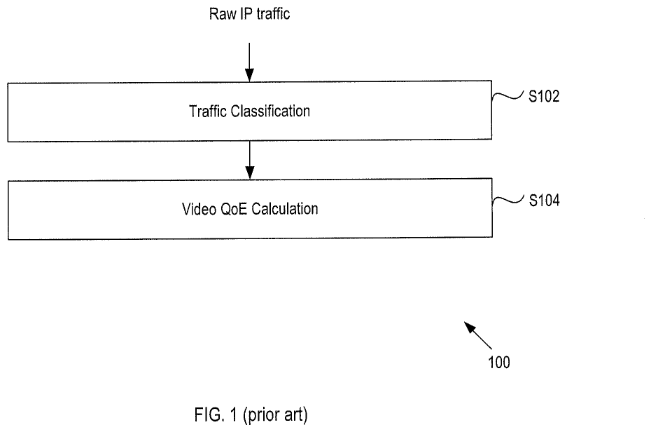

Raw IP traffic (IP packets) is processed and traffic classification is applied (S202), as is outlined above in relation to FIG. 1.

The output of traffic classification is, however, according to examples as described herein then fed into the audio/video segmentation module instead of the QoE calculation system directly. For different services, it may be necessary, in some examples, to use slightly different implementations of audio/video segmentation. The audio/video segmentation may filter out the audio content and stream the video-related content to the QoE measurement system, or it may stream both audio and video content with a flag that indicates which is which. Depending on the QoE measurement tool, its input interface may, in some examples, need to be adapted to the output stream of the audio/video segmentation system. By introducing the audio/video segmentation system, not only current state-of-the-art video QoE measurement systems can provide improved estimations, but it also makes it possible to provide audio QoE measurements by streaming the audio part of the traffic into an audio QoE calculation system.

Therefore, once the audio and video traffic is separated in the audio/video segmentation (S204), the video traffic may be analyzed in the video QoE calculation module (S206) and the audio traffic may be analyzed in the audio QoE calculation module (S208).

In classical (non-virtualized) networks, the solution may be implemented by a small set of nodes/network functions (NFs), as is shown in FIG. 2 in relation to the traffic classification module, the audio/video segmentation module, the video QoE calculation module and the audio QoE calculation module.

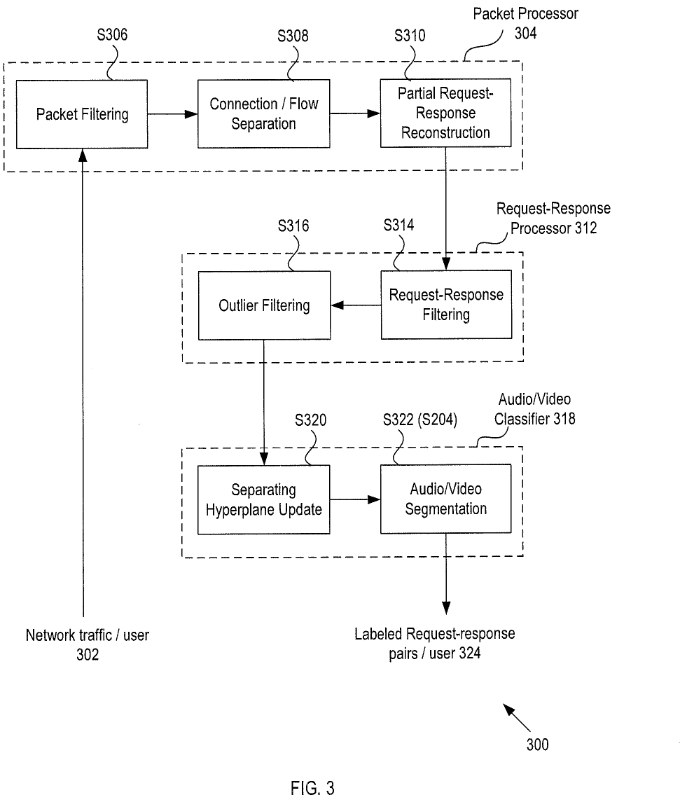

FIG. 3 is a flow diagram of a method 300 according to some example implementations as described herein.

In FIG. 3, the processes is described for a single subscriber, but it will be appreciated that the nodes/NFs may operate on multiple subscribers (in parallel).

Depending on the infrastructure, the solution may be implemented in two ways: either having three nodes/NFs (Packet Processor 304, Request-Response Processor 312, Audio/Video Classifier 318), or having seven nodes/NFs, one for each phase of the process, as indicated in FIG. 2. The three-node/NF implementation may group together closely linked steps of the process, separating them at interfaces with different output frequencies. This means that inside the Packet Processor 304, packets are processed which are the most frequent elements. From the packets, HTTP requests and responses are (partially) created, which usually consist of several packets, therefore reducing the frequency of the output (for example, for every ten packets, there may be one request). Each HTTP request is followed by an HTTP response, forming a pair—to this end, a request-response pair is handled as a single element.

In this example, network traffic is provided from a user 302 to the packet processor 304. The node/NF first filters incoming packets at step S306, for example in order to remove control messages, such as (but not limited to) acknowledgement (ACK) messages. This may be achieved by, e.g., comparing the size of the packets to a threshold—this way even messages of protocols on UDP may be handled (like Quick UDP Internet Connections (QUIC)).

Following this, each packet is, in this example, processed further, together with other packets that were transmitted over the same connection (e.g. over the same TCP session). In some examples, a connection/flow separation may be applied to the filtered packets at step S308. This is an important step, because a subscriber can have several open connections at the same time, but partial request-response reconstruction may, in some examples, only be done on a per-connection basis.

The partial request-response reconstruction is then performed in the packet processor 304 at step S310.

The request-response pair(s) is (are) then sent from the packet processor 304 to the request-response processor 312.

In the request-response processor 312, request-response filtering is applied at step S314 and outlier are filtered at step S316.

Afterwards, in this example, in the audio/video classifier 318, separating hyperplanes are updated at step S320, and audio/video segmentation is applied at step S322 (which may correspond to step S204 shown in FIG. 2). From the audio/video classifier 318, labelled request-response pairs are output (324).

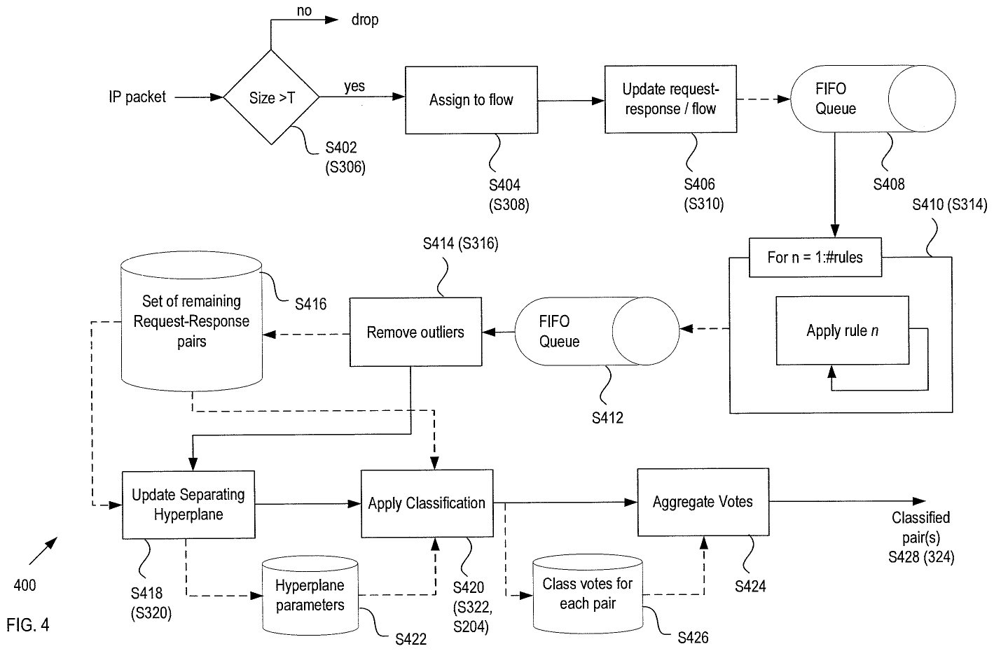

FIG. 4 is a flow diagram of a method 400 according to some example implementations as described herein, in which partial reconstruction is depicted.

Inside a connection, the request-response pairs may manifest as a series of one or more uplink packets (the request, fragmented when exceeding the Maximum Transfer Unit size), followed by a series of one or more downlink packets (the response, fragmented when exceeding MTU size). Using this pattern, packets may be grouped together that form the request and packets that form the following response, because a request always precedes the response. An uplink packet that follows a downlink packet may indicate the start of a new request, while a downlink packet that follows an uplink packet may indicate the start of the following response. The size of the packets between may be aggregated. When a new request is started, then the preceding request and response form a pair, which is then sent into a queue containing such pairs, waiting for further processing. This queue holds pairs from all connections for the given subscriber. This reconstruction scheme works, in this example, with two assumptions: 1) the server does not send requests to the client, and 2) there is no request multiplexing in the open connections. Note that while both assumptions could be violated theoretically, it is unlikely to happen in practice. Clients are supposed to send requests—even if they have to report something, it may happen in the form of a POST request, rather than the server sending a GET request to the client. Multiplexing is also something that is unlikely to happen. HTTP 1.2+ allows for different kinds of multiplexing, but these are meant for web traffic, where a lot of connections are opened and closed, which is time consuming and is avoided by multiplexing requests. However, video streams keep connections open, therefore overhead of connection creation is avoided. Also, there is no point in multiplexing requests due to the causal nature of requests: if the client quickly needs some part of a video (e.g. buffering phase at the start of a video or after a seek), then it does not help if some other parts arrive sooner, possibly taking away bandwidth from the most important part and risking a video freeze; also, if the client does not need a part quickly, then it is due to having a healthy buffer, therefore it may suffice to send only one request and append the response at the end of the buffer. Another reason for avoiding multiplexing is the BitTorrent effect: the more connections an application has, the higher its chance to send or receive data over a channel with limited capacity (due to the congestion control mechanisms built into transmission protocols).

In this example, it is determined at step 402 (which may correspond to step S306) in the packet processor 304 if the size of an IP packet is above a threshold (T) or not. If it is not above the threshold, in this example, the IP packet is dropped. If it is above the threshold, the IP packet is assigned to a flow at step S404 (which may correspond to step S308). Afterwards, the request-response/flow is updated at step S406 (which may correspond to step S310) and a pair is provided to a first-in, first-out queue (S408).

The request-response pairs are sent to the Request-Response Processor node/NF. This node/NF has lower hardware requirements, since there are much less request-response pairs than packets—processing them takes less effort. The node/NF applies a set of predefined rules at step S410 (which may correspond to step S314) (which may have to be adapted to the exact OTT video service provider) to filter out unnecessary pairs. For example, one may only be interested in the GET requests sent by the client to the server and the corresponding responses. However, there are different types of requests (e.g. POST, OPTIONS, etc.) with different characteristics. Usually, POST requests may be used by the client to send data to the server. To this end, the size of the request may be very large, while the response may be usually small (e.g. an acknowledgement message, like 200 OK). For GET requests, the request may contain only an URL and some cookies, therefore the request size may be small—however, the response contains the requested data, which may be much larger.

The pairs are then, in this example, provided to a further first-in, first-out queue (S412).

Some request-response pairs may bypass the filters though, causing potential issues. In order to defend the segmentation from these, outliers are, in this example, eliminated at step S414 (which may correspond to step S316).

It is to be noted that request-response pairs are stored in a FIFO queue (S412), which may simply be a time window. The number of elements in the time window is usually small (around 5-20) in order to have real-time output (if the periodicity is 30 seconds, then even 10 requests mean that requests from 5 minutes ago still affect the current output). The small number of elements prohibits the use of most statistical and machine learning techniques, only the simplest ones may have a chance. Since separation may be done based on the request sizes, it is considered, in some examples, to remove outliers based on request size only. Consider first how a time series of request sizes looks like: audio requests tend to be smaller, while video requests tend to be larger with respect to audio requests—if plotted over time, one may draw a horizontal line to separate the two. Using the idea of Fischer's linear discriminant, this may be achieved by calculating the average: the average may not be in the center, but it may separate the two classes. In small samples, outliers may have an especially large effect on the sample mean. This may be utilized to filter outliers as follows: copy the contents of the queue, calculate the mean request size, then calculate the ratio of requests that fall above this value; if this exceeds a predefined constant (meaning that there is a “significant” amount of requests above the mean), then those are not outliers since there are many of them. If the ratio of samples above the mean is small, then it indicates that a few requests pulled the mean upwards (leaving almost all other request under the mean), therefore they must have been outliers and should be removed from the copy. Here, one may also use the likely assumption that there are more video than audio requests; otherwise the video requests could seem to be outliers. After this, the mean is calculated again, but this time the ratio of samples below the mean is calculated: if this exceeds some threshold, then these requests are deemed audio requests because there are several of them; however, if there are only a few requests below the mean, they are considered lower outliers and should be removed from the copy.

The set of remaining request-response pairs may optionally be output separately (S416).

The Request-Response Processor then sends the filtered copy of the time window to the Audio/Video Classifier node/NF.

Once outliers are removed, (one or more) separating hyperplanes may be updated at step S418 (which may correspond to step S320). This may be performed by the audio/video classifier 318 node/NF based on the pairs once outliers are removed at step S414, and optionally based on the set of remaining request-response pairs (S416).

The discriminant function/separating hyperplane may be given by the sample mean. Each remaining request in the copy may be compared to this—if a request exceeds the mean, it is considered a video request, otherwise an audio request.

In this example, information from the updating of the separating hyperplane may optionally be provided to output hyperplane parameters (S422) which may be fed into the step of applying the classification (step S420, which may correspond to step S322 and/or S204), which may further optionally be based on the set of remaining request-response pairs (S416).

Note that as time goes by and the original window slides, it is possible to get different classifications for the same request. This can happen for example when a large level shift emerges in the Uniform Resource Locator (URL) of the GET requests, which will first be considered an outlier and removed from copies of the queue, but as more and more large requests are put into the queue and the older, smaller requests are shifted out, they may stop becoming outliers and may not be removed from the copy, hence their classification changes. To overcome this situation, it is possible to keep track of all class labels assigned to a request and use majority voting at the time when the request is shifted out of the queue. However, this can, again, introduce delay into the output (equaling the length of the window). In this example, once the classification is applied at step S420, class votes for each pair are performed at step S426 and provided as an input to the aggregation of the votes at step S424.

Finally, the classified request-response pair(s) is (are) output at step S428.

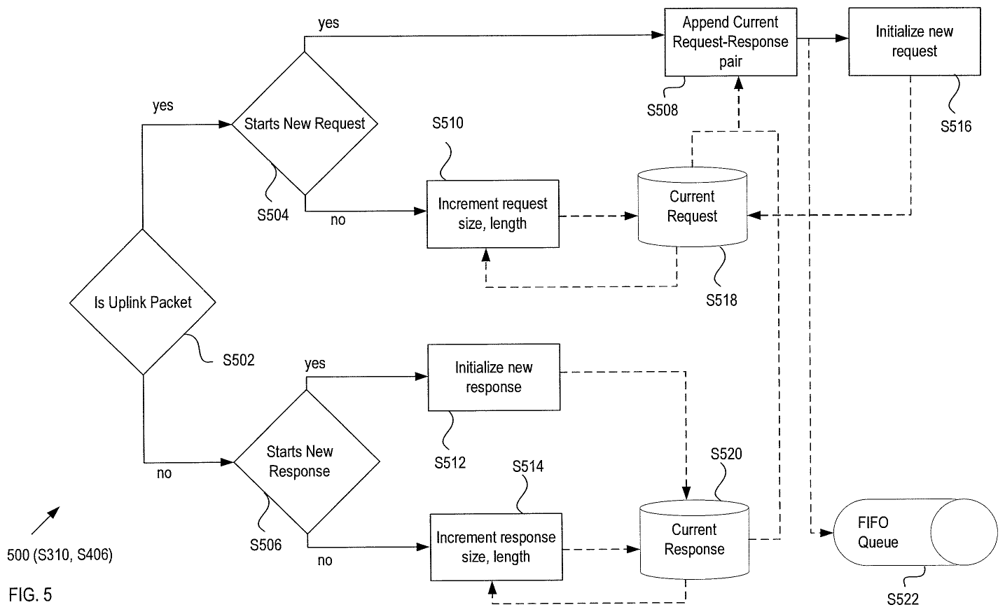

FIG. 5 is a flow diagram of a method 500 according to some example implementations as described herein. It depicts an example of partial request-response reconstructions (which may correspond to step S310 shown in FIG. 3 and/or step S406 shown in FIG. 4).

In this example, at step 502, it is determined if an uplink packet is present. If this is not the case, it is determined at step S506 whether a new response is started. If this is not the case, at step S514 the response size and/or length is incremented. If it is determined at step S506 that a new response is started, the new response is initialized at step S512. The output of step S514 and step S512, respectively, is output as a current response at step S520. The current response may be fed back to step S514 to increment the response size and/or length.

If it is determined at step S502 that an uplink packet is present, it is determined at step S504 whether a new request is started. If this is not the case, the request size and/or length is incremented at step S510. This is output to a current request S518, which may optionally be fed back to the performance of step S510 to increment the request size and/or length further.

The output of step S518 or step S520, or the output of the determination at step S504 that a new request is started is used to append a current request-response pair at step S508. Based on this, the new request is initialized at step S516, which may optionally be fed back to the current request generation at step S518.

In this example, the appended current request-response pair may be provided to the first-in, first-out queue at step S522.

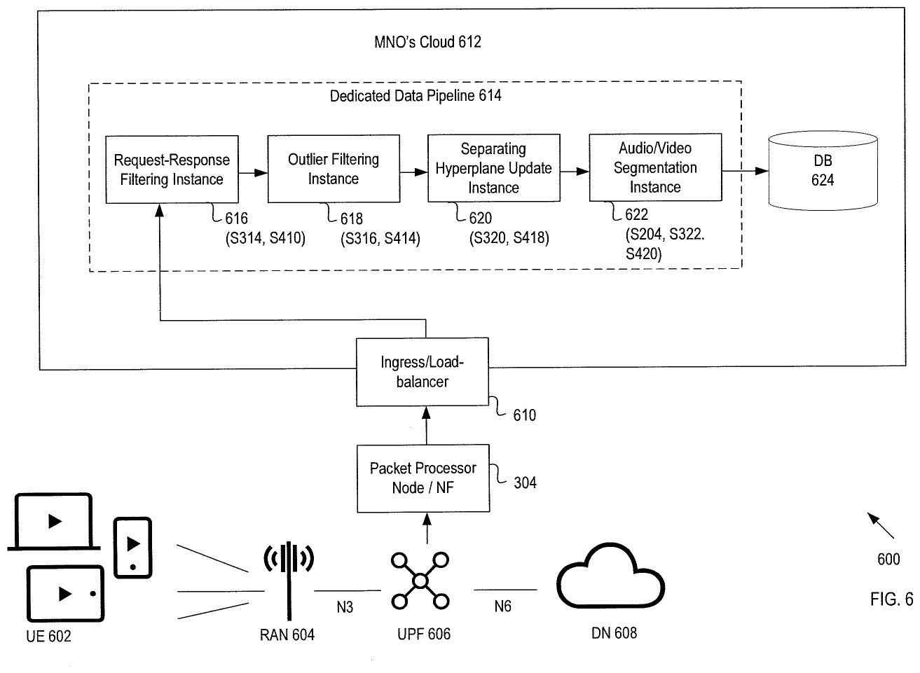

FIG. 6 is an implementation 600 according to some example implementations as described herein. It depicts an example cloud implementation of examples outlined throughout the present disclosure.

The examples described herein may be implemented in cloud environments, e.g. via Virtualized Network Functions (VNF) or Cloud-native Network Functions (CNF). An overview is presented in FIG. 6, depicting a possible connection with a 5G network.

As the solution's primary inputs are IP packets, the Packet Processor Node/NF 304 may need to have a direct connection with the User Plane Function (UPF) 606. In this example, the UPF 606 is coupled to data network 608 via an N6 interface, and to the RAN 604 (in which UEs 602 are provided) via an N3 interface.

The Packet Processor node/NF 304 may have a quite heavy load. Therefore, it may be good practice to keep it as a physical node/NF instead of a CNF or VNF. However, subsequent stages of processing may be less computationally intensive and may be implemented as a pipeline of CNFs/VNFs. Since each component of the system may keep track of a set of subscribers, the subscribers may be load-balanced to different instances of the components in the cloud 612 of the MNO; one single instance may not have enough memory, and it may also be important to assign every packet from a specific subscriber to the same component instances. This can be achieved by either creating network slices for different sets of subscribers and having instances of the pipeline in each slice or using some ingress load balancer 610 at the entry point of the cloud 612 (or a part of the cloud).

As can be seen, in this example, the ingress load balancer 610 is coupled to the request-response filtering instance 616, which, together with the outlier filtering instance 618, the separating hyperplane update instance 620 and the audio/video segmentation instance 622, is provided in the dedicated data pipeline 614.

The ingress load balancer 610 provides data to the request-response filtering instance 616 (which may correspond to performing of step S314 and/or step S410).

After the request-response filtering instance 616, outlier filtering 618 is performed (which may correspond to step S316 and/or step S414). Thereafter, separating hyperplane(s) updating 320 is performed (which may correspond to step S320 and/or step S418). Finally, audio/video segmentation 622 is performed (which may correspond to step S204 and/or step S322 and/or step S420).

Finally, the output of the audio/video segmentation instance 622 is coupled to database 624 for storing labelled request-response pairs. The database 624 is, in this example, provided in the MNO's cloud 612 as well.

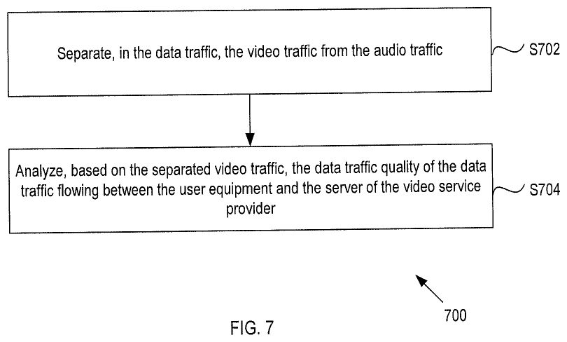

FIG. 7 is a flow diagram of a method 700 according to some example implementations as described herein.

The method 700 comprises, at step S702, separating, in the data traffic, the video traffic from the audio traffic. At step S704, the data traffic quality of the data traffic flowing between the user equipment and the server of the video service provider is analyzed based on the separated video traffic.

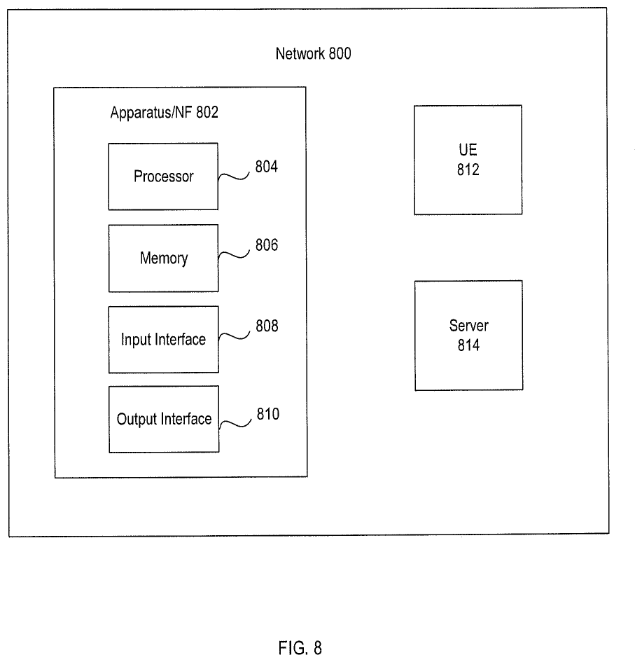

FIG. 8 is a block diagram of a network 800 according to some example implementations as described herein.

The network 800 comprises, in this example, an apparatus or network function 802 which comprises a processor 804, a memory 806, an input interface 808 and an output interface 810. The network 800 further comprises a user equipment 812 and a server 814 of a video service provider.

The apparatus or network function 802 is configured to analyze data traffic quality of data traffic flowing between the user equipment 812 and the server 814 of the video service provider, wherein the data traffic comprises video traffic and audio traffic. The apparatus or the network function 802 is configured to separate, in the data traffic, the video traffic from the audio traffic, and analyze, based on the separated video traffic, the data traffic quality of the data traffic flowing between the user equipment 812 and the server 814 of the video service provider.

It will be appreciated that the present disclosure has been described with reference to exemplary embodiments that may be varied in many aspects. As such, the present invention is only limited by the claims that follow.

1. A method for analyzing data traffic quality of data traffic flowing between a user equipment and a server of a video service provider, wherein the data traffic comprises video traffic and audio traffic, the method comprising:
separating, in the data traffic, the video traffic from the audio traffic; and
analyzing, based on the separated video traffic, the data traffic quality of the data traffic flowing between the user equipment and the server of the video service provider.

2. The method as claimed in claim 1, wherein the data traffic quality comprises a quality of experience relative to the data traffic.

3. The method as claimed in claim 2, wherein the quality of experience relative to the data traffic relates to a quality of experience of the video traffic.

4. The method as claimed in claim 1, further comprising, prior to said separating the video traffic from the audio traffic, reconstructing, from one or more data packets in the data traffic, one or more request-response pairs from corresponding, respective requests sent from the user equipment to the server and respective responses sent from the server to the user equipment, and
wherein said separating the video traffic from the audio traffic comprises separating the video traffic from the audio traffic within the one or more reconstructed request-response pairs, and
wherein said analyzing of the data traffic quality of the data traffic is based on the video traffic which is separated from the audio traffic within the reconstructed one or more request-response pairs.

5. The method as claimed in claim 4, wherein a plurality of said request-response pairs are reconstructed from a plurality of the data packets.

6. The method as claimed in claim 4, wherein said reconstructing is based on packet header information in the one or more data packets.

7. The method as claimed in claim 4, further comprising assigning the one or more data packets to one or more connections between the user equipment and the server, and wherein the one or more request-response pairs are reconstructed on a per-connection basis.

8. The method as claimed in claim 4, wherein processing the one or more data packets is performed by a network entity or network function which is different from a network entity or network function by which processing of the one or more request-response pairs is performed.

9. The method as claimed in claim 4, further comprising filtering out, prior to said separating of the video traffic from the audio traffic, one or more request-response pairs.

10. The method as claimed in claim 9, wherein the filtering out of the one or more request-response pairs is dependent on a said video service provider.

11. the method as claimed in claim 9, wherein whether to filter out a said request-response pair is based on a request size of a request, to which the request response-pair corresponds, sent from the user equipment to the server.

12. The method as claimed in claim 11, wherein a said request-response pair is filtered out if the request size is below an average request size of requests sent from the user equipment to the server over a predefined time period.

13. The method as claimed in claim 11, wherein a said request-response pair is filtered out (i) if the request size is above the average request size of requests sent from the user equipment to the server over the predefined time period and (ii) if a ratio of requests with request sizes above the average request size to all requests is below a predefined value.

14. The method as claimed in claim 12, wherein a said request-response pair is filtered out if the ratio of requests with request sizes below the average request size to all requests is below a further predefined value.

15. The method as claimed in claim 1, wherein the data traffic flows in an uplink direction from the user equipment to the server.

16. The method as claimed in claim 15, wherein said analyzing of the data traffic quality is based on a plurality of uplink data packets.

17. The method as claimed in claim 1, wherein said separating the video traffic from the audio traffic is performed while the user equipment receives video-content via the data traffic.

18. The method as claimed in claim 1, further comprising filtering out the audio traffic from the data traffic flowing between the user equipment and the server prior to said analyzing of the data traffic quality.

19. The method as claimed in claim 1, wherein the separated video traffic and the separated audio traffic each comprise a corresponding, respective indicator for indicating the separated video traffic and the separated audio traffic, respectively, and
wherein said analyzing of the data traffic quality is based on the separated video traffic indicated by the corresponding indicator.

20. The method as claimed in claim 19, further comprising analyzing, based on the separated audio traffic, the data traffic quality of the data traffic flowing between the user equipment and the server of the video service provider.

21.-42. (canceled)
